(19) United States
(12) Patent Application Publication
(10) Pub. No.: US 2010/0049445 A1
(43) Pub. Date: Feb. 25, 2010

(54) METHOD AND APPARATUS FOR SEQUENCING DATA SAMPLES

(75) Inventors: Yuriy Fofanov, The Woodlands, TX (US); Heather Koshinsky, El Cerrito, CA (US); Viacheslav Fofanov, Houston, TX (US); Chen Feng, Missouri City, TX (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignees: Eureka Genomics Corporation, Hercules, CA (US); University of Houston System, Houston, TX (US)

(21) Appl. No.: 12/487,496

(22) Filed: Jun. 18, 2009

Related U.S. Application Data
(60) Provisional application No. 61/074,150, filed on Jun. 20, 2008.

(51) Int. Cl. G06F 19/00

(52) U.S. Cl. 702/19

(57) ABSTRACT

A method for identifying non-host nucleic acid sequence using sequence data. The method of identifying non-host nucleic acid can include sequencing a sample into sequences and associating the sequences with a host genome and then exclude any sequences that are associated with the host genome. The method can then associate the sequences with any known genomes and exclude any sequences that are associated with any known genome. The remaining sequences can be used as seed sequences to assemble a non-host nucleic acid.

### CROSS REFERENCE TO RELATED APPLICATIONS

This patent application claims priority to U.S. provisional patent application No. 61/074,150, filed Jun. 20, 2008, and entitled “Method and Apparatus for Sequencing Data Samples”, the contents of which is incorporated herein in its entirety.

### FIELD OF THE DISCLOSURE

The present disclosure generally relates to sequencing data samples and, more specifically, to sequencing data samples to detect and identify non-host nucleic acid sequences.

### BACKGROUND

With the advent of nucleic acid sequencing, it has become possible to identify the presence of an organism based on the presence of its nucleic acids, without relying on the growth of the organism, or presence of non-nucleic acid macromolecules. Sequencing has also been used to identify the presence of previously unknown bacteria. These bacteria have been discovered in environmental sites (ocean, Antarctic, deep sea vents) and on the human body (oral, elbow crease, gut). In many examples, this discovery process is based on (1) “broad range” amplification with primers from highly conserved regions in the 16S ribosomal subunit, (2) obtaining sequence information for the variable region of the amplicon(s) that is between the primers, (3) comparing the sequence information to a database of the 16S sequences for known bacteria, (4) analyzing those sequences that are not in the database and determine which (if any) of the known bacteria are close relatives and (5) based on this “relatedness” assigning the bacteria associated with the new 16S sequence to a likely taxa, genus, species, etc. In one approach the conserved sequences are in the 16S/23S genes and produce an amplicon for sequencing in the variable internal transcribed spacer (ITS) region that is between them. In fungi, the approach is similar. The 18S/5.8S/28S genes are highly conserved and have the ITS1 and ITS2 between them, respectively, which are the variable regions that are sequenced and used for comparison.

However, this strategy is based on a single or a limited number of sites that have conserved regions. Conventional strategies rely on highly conserved regions. Such approaches provide a very narrow scope for comparison and determination of a new species. Whole genome approaches to finding new sequences are needed. Currently the sequencing capacity has been developed to generate the required data. However, there are no tools to effectively analyze this amount of data. These needs and others are the subject of the present disclosure.

### SUMMARY

Generally, the disclosure is directed to identifying known and unknown non-reference nucleic acid sequences (i.e., nucleic acid sequences that are not typically found in a reference, or source of nucleic acids) using sequence data. This can be achieved by comparing one or more sample sequences with reference sequences in a data structure and excluding one or more sample sequences that are associated with the reference sequences in the data structure, or by excluding all sequences that are associated with the nucleic acid sequence source (reference genome or genomes) and also excluding all sequences that can be associated with any known genome or gene. The disclosure is also directed to data structures that can be employed to identify non-reference nucleic acid sequences using sequence data. Files containing sequence data and other information can be loaded into the data structures, where the sequences can be used as the searchable key in the data structures. The disclosure also includes mapping a sample sequence to a reference sequence that includes any known genome with any number of mismatches. These and other advantages and features of the present disclosure will become apparent to those of ordinary skill in the art upon reading this disclosure in its entirety.

### BRIEF DESCRIPTION OF THE DRAWINGS

FIG. 1 depicts one representation of a system that can be used for described applications.

FIG. 2 is a flowchart depicting general operations of a method of identifying non-reference nucleic acid sequences by sequencing nucleic acid sequences in a sample.

FIG. 3 is a flowchart depicting operations of a method of separating the nucleic acid sequences of the sample from the reference genome sequence.

FIG. 4 is a flowchart depicting operations of a method of determining if the nucleic acid sequence of the sample is a previously identified genomic sequence.

FIG. 5 is a flowchart depicting operations of a method of identifying the unknown non-reference genome sequence by sequencing two samples.

FIG. 6 is a flowchart depicting operations of a method of separating sequences from the two samples that can be mapped to one another.

FIG. 7A and FIG. 7B are examples of data structures that can be used for lookup tables.

FIG. 8 is a flowchart depicting operations of a method of identifying non-reference nucleic acid sequence by mapping sample sequences exactly and with mismatches.

### DETAILED DESCRIPTION OF EMBODIMENTS

Generally, the disclosure addresses identifying known and unknown non-reference nucleic acid sequences (i.e., nucleic acid sequences that are not typically found in a reference genome, or source of nucleic acids) using sequence data. This can be achieved by comparing one or more sequences of the sample with reference sequences in a data structure and excluding one or more sequences of the sample that are associated with the reference sequences in the data structure. Further, this can be achieved by excluding all sequences of the sample that are associated with the nucleic acid sequence source and also excluding all sequences of the sample that can be associated with any known genome or gene. The remaining sequences of the sample are unknown non-reference sequences because they do not correspond to any of the reference sequences detected. In various embodiments, the remaining sequences of the sample can be used as seeds for the de novo assembly of unknown nucleic acid sequences not from the nucleic acid sequence source.

The disclosure includes data structures that can be employed to identify unknown non-reference nucleic acid sequences using sequence data. Files containing sequence data and other information can be loaded into the data structure, where the sequences can be used as the searchable key in the data structure. Further, the data structure can allow all sequences contained in the data structure to be simultaneously considered when mapping a sequence of the sample to a reference genome sequence and/or any known genome or gene. Additionally, the methodologies described herein can exhaustively map a sample sequence to reference sequences and also need not rely upon incomplete matching heuristics.

The disclosure also includes mapping a sequence of the sample to a reference sequence that includes any known genome with any number of mismatches (i.e. insertions, deletions, or substitutions of nucleic acids). For example, the sequence of the sample can be mapped to the reference sequence with no mismatches. If the sequence of the sample does not map to the reference sequence with no mismatches, the sequence of the sample can be mapped to the reference sequence with one mismatch. If the sequence of the sample does not map to the reference sequence with one mismatch either, the sequence of the sample can be mapped to the reference sequence with any number of mismatches until the sequence of the sample maps to the reference sequence. In general, once the sequence of the sample maps to the reference sequence with k number of mismatches, the sequence of the sample need not be mapped to the reference sequence with k+1 number of mismatches. In another example, if the sequence of the sample exactly maps to the reference sequence, then the sequence of the sample need not be mapped to the reference sequence with one mismatch.

Furthermore, in one example, all sequence data reads may be inserted into a lookup table by reducing the sequence data reads into addresses in the lookup table. Next, every subsequence of size N may be determined across the reference sequence, such as the host genome, and then all possible variants with 0-k mismatches can be determined and then determine whether any of the possible mismatch variants match any of the addresses already occupied by sequences from the sample. This approach may be exhaustive and moreover, no sequence alignment may take place. All possible variants may be generated with a given number of mismatches, however these may not be stored and instead, the variations may be iteratively processed.

Another embodiment can take the form of a one-sample sequencing approach. In such an approach, a determination can be made for every nucleic acid sequence of the sample as to whether the sequence can be mapped to a reference genome exactly (i.e., with no mismatches). Sequence of the sample that can be exactly mapped to a reference genome are excluded from the list of potential non-reference nucleic acid sequence members. A determination can then be made as to whether any of the remaining sequences of the sample can be mapped to the reference genome with one, two, three and so on mismatches as appropriate or desired. The remaining sequence of the sample that can be mapped to the reference genome with k mismatches can be excluded from the list of potential non-reference nucleic acid sequences. Additionally, the number of mismatches k, may be a user chosen parameter. For example, N may be the length of the nucleic acid sequence. Thus, as long as k/N is higher then the sequencing error rate, then k may be a sufficient choice by the user. Further, the number of mismatches may depend on a number of factors such as the mutation rate in the organism, genomic variability of the organism, the sequencing error rate and so on.

Yet another embodiment can take the form of a two-sample sequencing approach. In such an approach, for example a sample from tissue affected by a disease or disorder may be sequenced, and then a sample from (apparently) healthy tissue of the same organism may be sequenced. Next, all sequences that are common to both samples can be excluded. Optionally, all sequences associated with any known genome or gene also can be excluded. Optionally, the remaining sequences of the sample can be used as seed sequences for the de novo assembly of potential unknown non-reference nucleic acid sequence.

It should be noted that embodiments of the present disclosure can be used for any type of sequencing data or in any method used to identify non-reference nucleic acid sequence. The embodiment can include or work with a variety of nucleic acid sequence data, including DNA data, RNA data, methylated DNA data, data sequencing systems, data sequencing computations and methodologies, and the like. Aspects of the present disclosure can be used with practically any apparatus related to data sequencing and data sequencing devices or any apparatus that can relate to any type of data system, or can be used with any system in the identification of non-reference nucleic acid sequence. Accordingly, embodiments of the present disclosure can be employed in computers, data processing systems and devices used in data sequencing, and the like.

Before explaining the disclosed embodiments in detail, it is to be understood that the disclosure is not limited in its application to the details of the particular arrangements shown, and is capable of being realized in still other embodiments. Moreover, aspects of the disclosure can be set forth in different combinations and arrangements to define disclosures unique in their own right. Also, the terminology used herein is for the purpose of description and not of limitation.

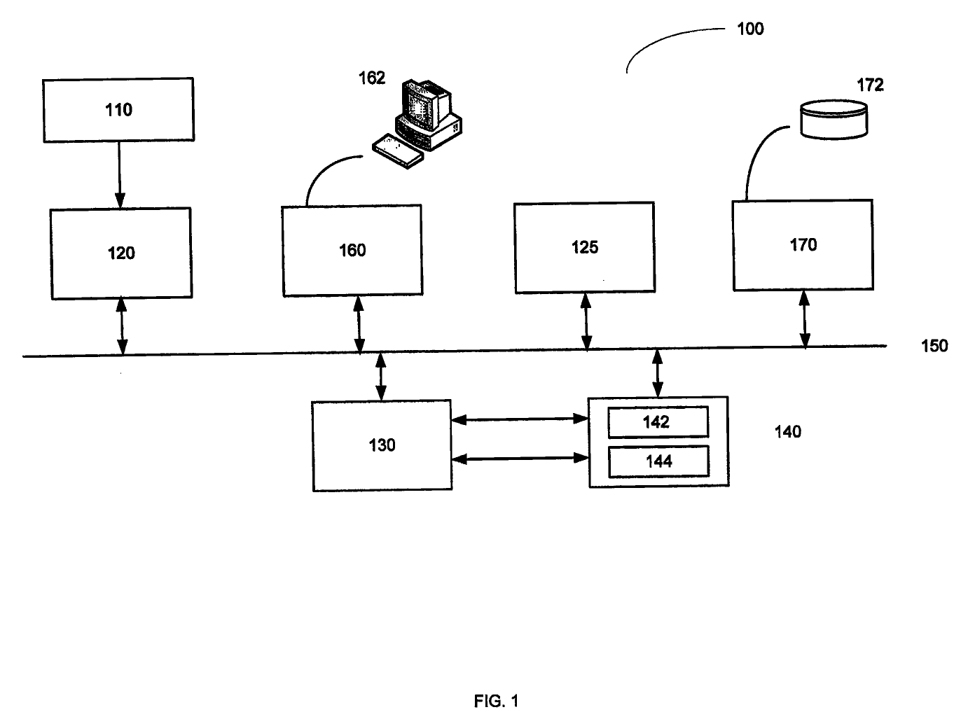

FIG. 1 depicts one representation of a system 100 for genome sampling, which may be implemented as any suitable computing environment that can be configured to conform with various aspects of the present disclosure. Generally speaking, a sample 110 can be sequenced using a sequencing system 120, where the sequencing system 120 can be any method of sequencing as described herein, such as (but not limited to) the Applied Biosystem 3730xl, the 454 Life Science GSFLX, the Illumina Genome Analyzer (classic and II), the Applied Biosystem SOLiD, the Helicos Heliscope, and the like. Although only one sample is illustrated as being sequenced for explanatory purposes, it should be understood that two samples or more can also be sequenced. Further, multiple sequencing systems 120 can be employed in the overall system 100.

The sequencing system 120 can connect to the computing environment by any methods, such as through proprietary, local or wide area network, and the like. The sequencing system 120 can connect to a server 130 and to a central processing unit 140 (“CPU”) via a communication bus 150. The CPU 140 can include a processor 142 and a main memory 144. The main memory 144 is a computer readable storage medium that is operable to store applications and/or other computer executable code which runs on the processor 142. The memory 144 may be volatile or non-volatile memory implemented using any suitable technique or technology such as, for example, random access memory (RAM), disk storage, flash memory, solid state and so on. There can be one CPU or multiple CPUs for the system 100. It is also possible for the server 130 and the CPU 140 to be one system or separate systems in the computing environment.

In one example, various devices in the system 100 can also communicate with each other through the communication bus 150. Although only one communication bus is illustrated, this is done for explanatory purposes and not to place limitations on the system 100. Generally, multiple communication buses can be included in any computing environment. As shown in FIG. 1, the server 130 and the CPU 140 can communicate directly with one another or through the communication bus 150. Additionally, sequence data produced by the sequencing system 120 may be communicated to the CPU 140, the main memory 144, the server 130, and the like via the communication bus 150. Various elements of the system 100, such as the CPU 140, may also employ various computing elements such as databases, data structures, processors configured to manage data structures and sequence data, and the like.

A user input interface 160 and a data storage interface 170 can also be connected to the communication bus 150. The user input interface 160 can allow a user to input information and/or to receive information through one or multiple input devices such as input device 162, within the hosted development environment or to the client systems 110. The user inputs can include various elements such as a keyboard, a touchpad, a mouse, any type of monitor including CRT monitors and LCD displays, speakers, a microphone, and the like. The data storage interface 170 can include data storage devices such as data storage device 172 (including databases, hard drives, tape drives, floppy drives, and the like).

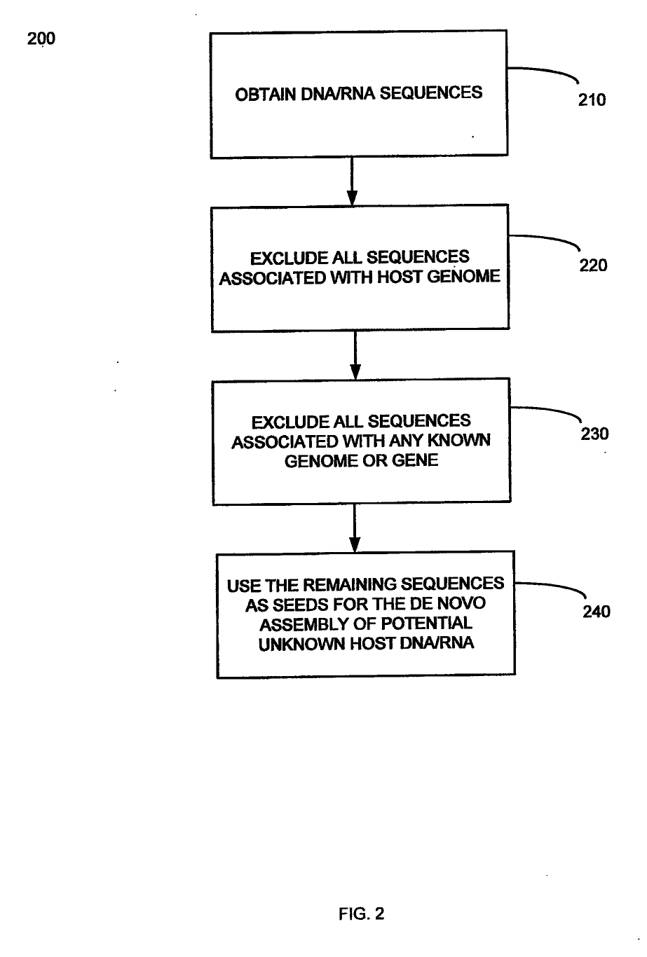

FIG. 2 is a flowchart 200 depicting operations of one embodiment of sequencing a sample for identification of unknown non-reference nucleic acid sequences. The method of flowchart 200 can be referred to herein as the “one-sample sequencing approach.” The sample can contain any nucleic acid sequence, e.g. DNA, RNA and any combination thereof. Alternatively, the sample can be an environmental sample (such as, water, air, soil and so on), a clinical sample (such as, urine, stool, infected tissue, diseased tissue and so on), food samples such as agricultural products.

Further, when sequencing the sample, either or both of the DNA and/or RNA nucleic acid sequences can be simultaneously considered. For example, a virus can appear in the sample as DNA, single-stranded RNA, or double stranded RNA. Even though the virus can appear as any one of these forms, the virus can still be detected in the sample because either or both of the DNA and/or RNA can be simultaneously considered. Further, the methodologies described herein can exhaustively map a sample sequence to reference sequences and also need not rely upon incomplete matching heuristics.

The nucleic acid sequence can be identified by any sequencing methods known in the art. In FIG. 2, in the operation of block 210, the nucleic sequences of the sample can be obtained using any sequencing technology known in the art.

In one non-limiting embodiment, the nucleic acids in the sample can be sequenced by Maxam Gilbert sequencing. Maxam Gilbert sequencing is “chemical sequencing” based on chemical modification of DNA and subsequent cleavage at specific bases. Classically, nucleic acids are radioactively labeled at one end and the DNA fragment to be sequenced. is purified Chemical treatment generates breaks at a small proportion of one or two of the four nucleotide bases in each of four reactions (G, A+G, C, C+T). Thus a series of labeled fragments is generated, from the radiolabelled end to the first ‘cut’ site in each molecule. The fragments in the reactions are then size-separated by gel electrophoresis and the order of the bands indicates the sequence.

In another non-limiting embodiment, the nucleic acids in the sample can be sequenced by Sanger sequencing. The Sanger method is based on termination of DNA synthesis in a small portion of molecules. The label can be radioactively or fluorescently labeled nucleotides or primers. The DNA sample is divided into four separate sequencing reactions, containing the four standard deoxynucleotides and the DNA polymerase. To each reaction is added a small concentration of only one of the four dideoxynucleotides (ddATP, ddGTP, ddCTP, or ddTTP). Incorporation of a dideoxynucleotide into the elongating DNA strand terminates extension, resulting in various DNA fragments of varying length. The reactions are then size-separated by gel electrophoresis and the order of the bands indicates the sequence.

In another non-limiting embodiment, the nucleic acids in the sample can be sequenced by dye-terminator sequencing. Dye-terminator sequencing is an alternative to the chain-termination in that the four ddNTPs each have a separate fluorescent label. This allows for a single reaction mixture and single lane on the gel.

In another non-limiting embodiment, the nucleic acids in the sample can be sequenced by sequencing by synthesis. The incorporation of the next base is observed, instead of the observing the termination of synthesis. In another non-limiting embodiment, the nucleic acids in the sample can be sequenced by pyrosequencing. Pyrosequencing is based on detecting the activity of DNA polymerase with a chemiluminescent enzyme. The template DNA is immobilized, and solutions of A, C, G, and T nucleotides are added sequentially. Light is produced only when the nucleotide solution complements the first unpaired base of the template. The sequence of solutions which produce chemiluminescent signals allows the determination of the sequence of the template. The light can occur in low throughput in or high throughput on an array (454 (Roche) with the GS FLX.).

In another non-limiting embodiment, the nucleic acids in the sample can be sequenced by reversible terminator sequencing (also a sequencing by synthesis method). This method is similar to dye-terminator sequencing, but differs in that reversible versions of dye-terminators are used. One nucleotide at a time is added by the polymerase. The fluorescence corresponding to that position is detected. The blocking group of the terminator NTP is removed. This allows the polymerization of another nucleotide (Illumina and Helicos).

In another non-limiting embodiment, the nucleic acids in the sample can be sequenced by sequencing by ligation. This method uses a DNA ligase enzyme to identify the target sequence. Used in the polony method and in the SOLiD technology (Applied Biosystems, now Invitrogen). There is a pool of all possible oligonucleotides of a fixed length, labeled according to the sequenced position. Oligonucleotides are annealed and ligated; the preferential ligation by DNA ligase for matching sequences results in a signal corresponding to the complementary sequence at that position.

In another non-limiting embodiment, the nucleic acids in the sample can be sequenced by “sequencing by hybridization.” This method uses a microarray. A single pool of DNA is fluorescently labeled and hybridized to an array of known sequences. If the DNA hybridizes strongly to a given spot on the array, causing it to “light up”, then that sequence is inferred to exist within the DNA being sequenced.

Other sequencing methods currently under development may include nanopore sequencing, sequencing by labeling the DNA polymerase and sequencing by electron microscope.

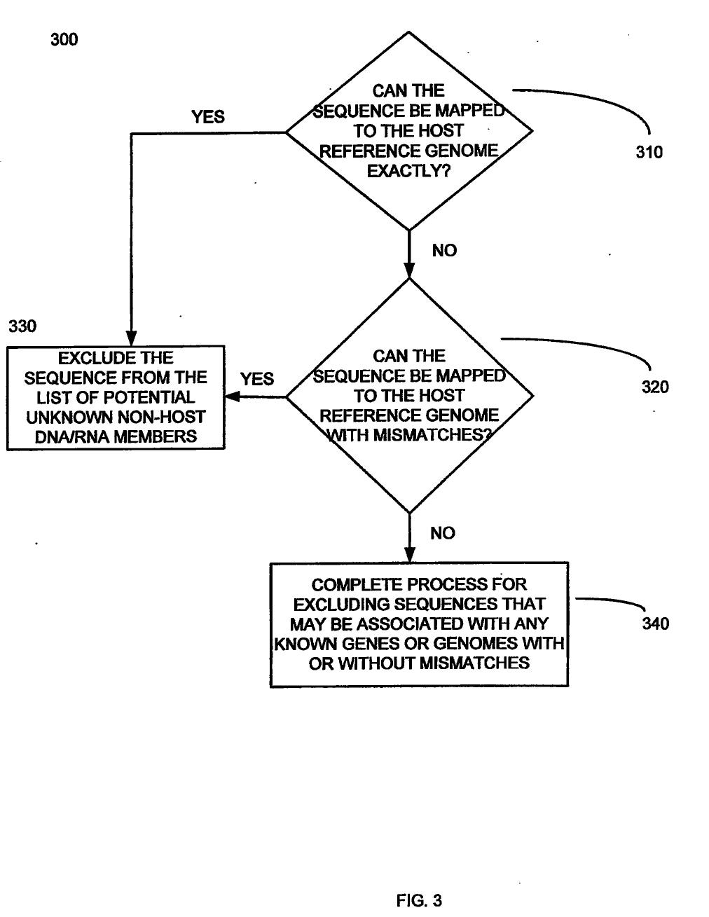

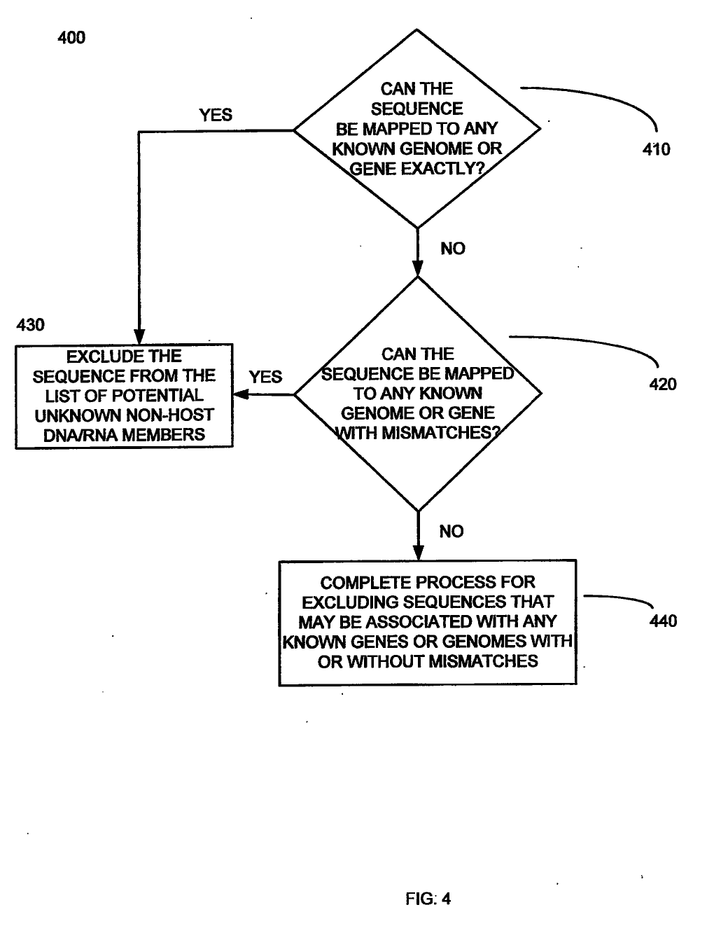

Next, in the operation of block 220, the nucleic acid sequences of the sample that can be associated with the reference genome can be excluded from the list of potential unknown non-reference sequences. The operation of block 220 will be discussed in more detail with respect to FIG. 3 below. In the operation of block 230, nucleic acid sequences of the sample that can be associated with any known genome or gene can be excluded from the list of potential unknown non-reference sequences. The operation of block 230 will also be discussed in more detail below with respect to FIG. 4.

In the operation of block 240, the remaining sequences of the sample can be used as seed sequences for the de novo assembly of potential unknown non-reference nucleic acid sequences. The remaining sequences of the sample can be the sequences of the sample after all sequences associated with the reference genome have been identified and excluded and all sequences of the sample associated with any known genomes or genes have been identified and excluded. Excluding sequences of the sample associated with the sample genome and with any reference sequence (e.g. known genome or gene) will be discussed in further detail below with respect to FIGS. 3 and 4. The de novo assembly uses seed sequences of unknown non-reference nucleic acid sequences, and can allow the larger sequences from these seed sequences to be reassembled using very short sequences (such as under 50 base-pairs in length), and can allow quality monitoring using the ratio of known sequences from the sample or other known genomes or genes and the unknown non-reference genomic material (or stated differently, can determine and/or assign the probability that the assembled sequence is actually an unknown non-reference nucleic acid sequence).

Additionally, the de novo assembly process can be similar for both the one-sample and the two-sample sequencing approaches (the two-sample sequencing approach will be discussed in further detail below). The de novo assembly process, for either approach, can use the sequences of the sample that have passed all of the mapping filtration steps as seed sequences. Both the sequences that passed the filters and the sequences that did not pass the filters can be used in the assembly process. For example, the assembled sequences can have an associated “score” or quality of the assembled sequences that can indicate the number of sequences from the excluded categories and the number of sequences from the passed categories. The score can allow the identification of which sequences can be newly identified non-reference nucleic acid sequence and which sequences can be from known genomes or genes.

For example, category A can have sequences of the sample that can be mapped to the reference genome (with or without mismatches) and category B can have sequences of the sample that can be mapped to the known non-reference genomes or genes (non-host but still genomic material, with or without mismatches). Category C can have sequences of the sample that passed all the filters from either the one-sampling or two-sampling sequencing approach. Continuing this example, for de novo assembly from a sequence from category C, the number of sequences can be monitored from each category that were used to extend the assembly. Then, for each assembled contig, the ratio can be calculated between the number of subsequences that are in categories A, B or C. If the majority of sequences to assemble the contig came from category A, it can be concluded that the contig can be more likely to be associated with the reference genome than the non-reference sequence genomic material. Alternatively, if the category B sequences are predominant in the assembly, it can be concluded (and possibly, the exactly genome source can be identified) that the contig can be associated with the non-reference but known genomic material. However, the contig may also consist of predominantly category C sequences and this may contribute to evidence of the identification of a new unknown non-reference genome organism.

FIG. 3 is a flowchart generally describing the operations of one embodiment of a method 300. The method 300 can include the operation of block 310, determining whether the nucleic acid sequences of the sample can be mapped to the reference genome, without mismatches, and then the method of block 330, can exclude the nucleic acid sequences of the sample that can be mapped to the reference genome. Stated differently, all sequences of the sample that can be exactly mapped (without mismatches) to the reference genome can be excluded from potential non-reference nucleic acid sequence members. The sequence data or sequences of the sample can be mapped exactly, without mismatches to multiple reference sequences from the same species (if available). Mapping will be discussed in more detail below. The reference sequence and/or sequences can be obtained from public databases, non-public databases, through direct sequencing of the reference genome, through direct sequencing of close relatives to the reference genome, and the like. Additionally, mismatches can include one or any combination or multiple combinations of insertions, deletions and/or substitutions.

Also in FIG. 3, the determination of whether the sequence of the sample can be exactly mapped to the reference genome can be made for every nucleic acid sequence of the sample. The methodologies for mapping the sequence data or sequences of the sample to the reference genome exactly (with no mismatches) can be employed using various data structures. The use of some data structures can avoid the comparison and alignment of each individual sequence of the sample to the reference genome sequence separately. Instead, by using certain data structures, each sequence observed in a sample can be assigned to a unique address in the data structure. Accordingly, the reference genome sequence can be used once to simultaneously identify all sequence data or sequences of the sample that can be present in the genome with zero mismatches. Various data structures and the implementation of the various data structures will be discussed in more detail below.

The operation of block 310 can continue until the nucleic acid sequences of the sample cannot be exactly mapped to the reference genome sequence. At the point when the nucleic acid sequences of the sample cannot be exactly mapped to the reference genome, the method proceeds to the operation of block 320. In the operation of block 320, the nucleic acid sequences of the sample that can be mapped to the reference genome with one or any combination of one, two, three or more mismatches, can be excluded from potential non-reference nucleic acid sequence members. As mentioned previously, mismatches can include one or any combination of insertions, deletions and/or substitutions. For example, a mismatch of two can include an insertion and a deletion and a mismatch of three can include an insertion, a deletion and another insertion in the nucleic acid sequence data. When the of the sample cannot be mapped to the reference genome with mismatches, as deemed necessary, the process is complete for excluding sequences that can be associated with the reference genome, as depicted in the operation of block 340.

FIG. 4 is similar to FIG. 3 and is a flowchart depicting operations of an embodiment of another method 400, which includes the process for excluding nucleic acid sequence data or sequences of the sample associated with any known genomes or genes. In method 400, the operation of block 410 includes determining if the nucleic acid sequence data or sequences of the sample can be associated with any known genomes or genes. The nucleic acid sequence data or sequences of the sample that can be mapped to any known genome or gene exactly (without mismatches) can then be excluded as depicted in the operation of block 430. As depicted in the operation of block 430, the nucleic acid sequence data or sequences of the sample that can be mapped exactly to any known genome or gene can be excluded from potential unknown non-reference nucleic acid sequence members. The nucleic acid sequence data or sequences of the sample can be mapped to a database of over 500,000 genomes and genes. The database of genomes and genes can be continuously updated and can include genome sequences for eukaryotes (such as human, cow, monkey, drosophila, yeast and so on), bacteria, viruses, and the like.

The method 400 can continue to the operation of block 420 once the nucleic acid sequences of the sample cannot be mapped exactly to any known genome or genes in the database. In operation of block 420, all the nucleic acid sequences of the sample that can be mapped to the collection of known genomes and genes with mismatches can be determined. As discussed with respect to FIG. 3, the mismatches can include one, two, three or more mismatches, where the mismatches can include one or any combination or multiple combinations of insertions, deletions and substitutions. The data structures and methodologies that can be used for associating the nucleic acid sequences of the sample with known genomes or genes can be similar to those used in the operation of block 320 in FIG. 3, excluding sequences of the sample associated with the reference genome. The data structures and methodologies will be discussed in more detail herein. The nucleic acid sequences of the sample that are mapped to the collection of known genomes and genes with mismatches, can be excluded in the operation of block 430. The operation of block 420 can continue until no nucleic acid sequences of the sample can be mapped to the collection of known genomes and genes with mismatches, and then the method 400 can be completed in the operation of block 440.

It should be noted that the one-sample sequencing approach for identification of unknown non-reference nucleic acid sequences can also be attempted using a brute force de novo sequencing method. This approach does not exclude sequences associated with the host genome, but rather uses all sequencing sample reads as seeds for de novo assembly. The assembled sequences can be mapped to all available/known gene and genome reference sequences, such as those publicly available through GenBank sequences, to obtain positive or suggestive identification of the source of genomic sequences.

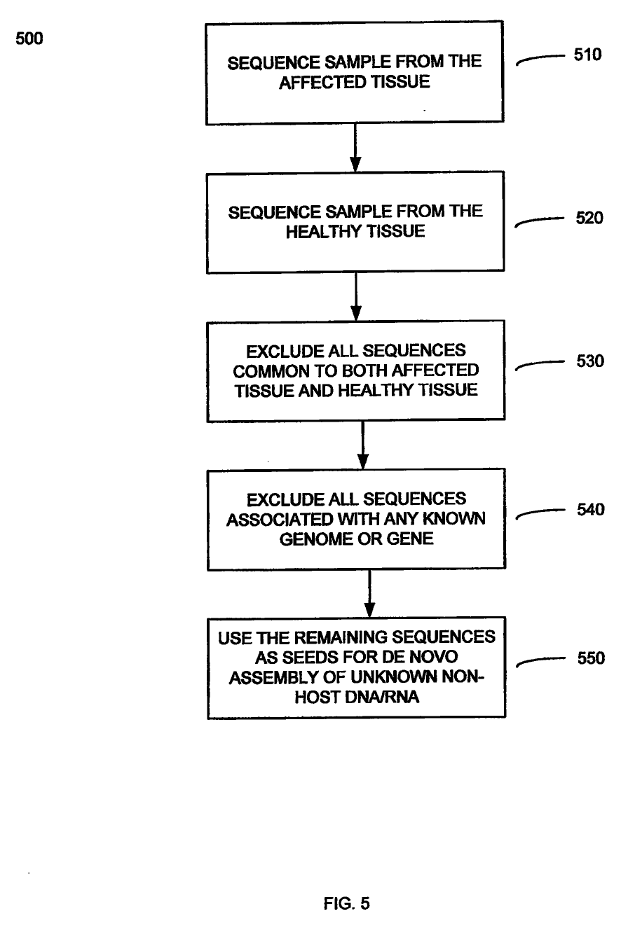

FIG. 5 is a flowchart generally describing operations of one embodiment of a method 500 which includes using at least two samples for sequencing and identifying unknown non-reference nucleic acid sequences. The method 500 can be referred to herein as the “two-sample sequencing approach.” The two-sample sequencing approach can obtain sequence data for at least one sample which can be from apparently healthy tissue of an organism (the control containing reference nucleic acid sequences, as used in various embodiments herein) and a second sample which can be affected tissue from the same organism (the comparison tissue or sample, as used in various embodiments herein). The method 500 can use a modified step-wise exclusion methodology and can exclude nucleic acid sequences associated with the reference genome and can also exclude known genomes and genes. The method 500 can be similar to the one-sample sequencing approach of method 200, with at least the exception that sequence data is obtained for at least two samples, one apparently healthy tissue sample and a comparison tissue sample (for example affected), both from the same organism. Similar to method 200, the methodologies described herein can exhaustively map the control sequence to the comparison sequences and also need not rely upon incomplete matching heuristics.

The operation of block 510 of method 500 can sequence the sample from the affected tissue (the comparison sample). Similarly, the operation of block 520 can sequence the sample from the apparently healthy tissue of the same organism as the comparison sample tissue. The operations of blocks 510 and 520 can also be performed in the opposite order and the samples can be sequenced, as discussed previously. Sequencing the comparison sample first and the healthy sample (control) second, is for explanatory purposes only, and generally the sequencing can be performed in either order or at the same time (at different locations/lanes, etc).

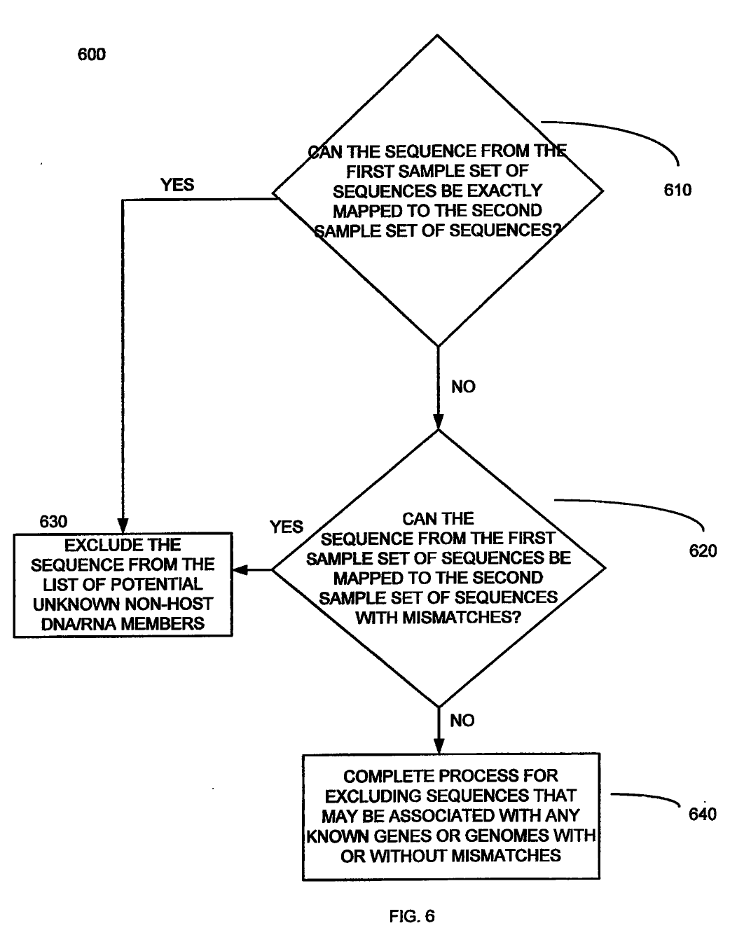

Next, in the operation of block 530, all sequences that are common to both the control sample and the comparison sample can be excluded. FIG. 6 is a more detailed description of the operation of block 530 of FIG. 5 and describes the process of excluding all sequence sequences that can be common to both the comparison and control samples. The operation of block 610 of FIG. 6 directly maps the comparison sample set of sequences to the set of sequences from the control sample. As shown in the operation of block 630, all the comparison sample set of sequences that can be directly mapped to the set of sequences from the control sample can be excluded from the list of potential non-reference nucleic acid sequence members.

Next in the operation of block 620, the comparison sample set of sequences can be mapped to the control sample set of sequences with any combination of one, two, three or more insertions, deletions and/or substitutions (mismatches). The comparison sample set of sequences that can be mapped to the control sample set of sequences with mismatches can be excluded from the comparison sample sequence, i.e., from potential non-reference nucleic acid sequence members in the comparison sample sequence in the operation of block 630. Once the comparison sample set of sequences cannot be mapped to the control sample set of sequences with mismatches, the method 600 completes in the operation of block 640.

Returning to FIG. 5, in the operation of block 540, all sequences associated with any known genome or gene can be excluded. The operation of block 540 can first exclude the remaining comparison sample sequence data (sequences) that can be mapped exactly, with no mismatches, to a database of over 500,000 genomes and genes. Then, the operation of block 540 can exclude the remaining sequences that can be mapped to the database of known genomes and genes with mismatches or any combination of one, two, three or more insertions, deletions and/or substitutions. The operation of block 540 can be similar to the operation of block 420 of FIG. 4. Then, in the operation of block 550, the remaining sequences can be used as seed sequences for the de novo assembly of potential unknown non-reference nucleic acid sequence. Using the seed sequences for the de novo assembly will be discussed below.

Various data structures can be used to implement the methodologies discussed above. Following is a detailed discussion of data structures and the implementation of data structures, mapping, assembly and various applications of the one-sample sequencing approach and the two-sample sequencing approach. The various data structures can include and/or employ sequences that can be organized in the data structure, where the sequences can be available in two formats, base-only and base-and-quality. Each base of a sequence in the base-only format belongs to an alphabet such as {A, T, G, C, N} for DNA, or {A,U,G,C,N} for RNA where N means a given base has not been determined by sequencing method Each base of a sequence in the base-and-quality format is a pair (b,qi) where b is in an alphabet {A, T, G, C, N} for DNA, or {A,U,G,C,N} for RNA and qi where i=1 to sequence size are the probabilities of error (using next generation sequencing, the probability that a given base is determined incorrectly).

In various aspects, the number of reference sequences (e.g. host sequences) are several orders of magnitude greater than the number of unidentified sequences. In various non-limiting examples, the reference sequence can be present in a proportion on the order of 10⁵, 10⁶, 10⁷, 10⁸, 10⁹, or 10¹⁰ greater than the non-reference sequence. The number of sequences of reference sequence and non-reference sequences in the data structure can thus be chosen to have multiple non-reference sequences in a given sample.

In one non-limiting example, in the case of a virus infecting a host, a virus with a 10 kb genome is integrated entirely into a single chromosome location in all cells in the affected human tissue (sample one). The human haploid genome is 3.2 Gb, so each human cell has approximately 6.4 Gb genomic material. If DNA is obtained from these cells, the virus DNA represents approximately six orders of magnitude less than of the DNA obtained from the human. If short sequences are randomly generated from the sample, then 1 of every 1 million reads should be the virus DNA. Thus in this scenario the theoretical minimum of sequencing information that is required is 1 million sequences.

In various aspects, the size of the obtained sequences can determine the total amount of sequencing data. If the sequences are each on average 50 bases in length, then 10⁶ sequences represents 50 Mb of sequence information. If the length of the sequences is 36 bases, then 10⁶ sequences represents 36 Mb of sequencing data. If this single detected sequence is different from all sequences (in this case host sequences) in the reference sequences in a second data set (e.g. partial or entire human genome) by 1 or more bases (mismatches include substitutions, insertions or deletions in any position and in any combination), then the described method would identify the sequence as is characteristic of sample one (i.e. or non-host nucleic acid sequence) and use the sequence in conjunction with a search algorithm to find a known homologous sequence and a potential identity of the non-reference DNA. In most cases, selecting the average number of non-reference sequences to be one is not preferred, so the number of non-reference sequences likely to be identified can be increased by increasing the number of reference sequences that are entered into the data structure.

In another non-limiting example, a bacterium with a 5 Mb genome is associated with all of the cells in the affected tissue (sample one). The human haploid genome is 3.2 Gb, so each human cell has approximately 6.4 Gb genomic material. The bacterial DNA represents approximately three orders of magnitude less than the DNA obtained from the sample. If 50 base sequences are randomly generated from the sample, then approximately 1 of every 4 thousand reads should be bacterial DNA. Thus, in this scenario, the theoretical minimum sequencing information that is required is 4 thousand sequences.

If the sequences are each on average 50 bases in length, then 4000 sequences represents 0.4 Mb of sequence information. If the length of the sequences is 36 bases, then 4000 sequences represents 0.15 Mb of sequencing data. If this single detected sequence is different from all sequences (in this case host sequences) in the reference sequences in a second data set (e.g. partial or entire human genome) by 1 or more bases (mismatches include substitutions, insertions or deletions in any position and in any combination), then the described method would identify the sequence as is characteristic of sample one (i.e. or non-host nucleic acid sequence) and use the sequence in conjunction with a search algorithm to find a known homologous sequence and a potential identity of the non-reference DNA. In most cases, selecting the average number of non-reference sequences to be one is not preferred, so the number of non-reference sequences likely to be identified can be increased by increasing the number of reference sequences that are entered into the data structure.

In another non-limiting example, a virus with a 10 kb genome is associated with 10% of the cells in an affected tissue (sample one). The human haploid genome is 3.2 Gb so each human cell has approximately 6.4 Gb genomic material (change to 10 Gb to make math simpler). If DNA is obtained from these cells, the bacterial DNA represents approximately 1/10,000,000 of the total DNA obtained. If 50 b sequences are randomly generated from the sample, then 1 of every 10 million reads on average is viral DNA. Thus in this scenario the theoretical minimum of sequencing information to obtain a single viral sequence is 10 million reads. (As above, the size of the reads can determine the total amount of sequencing data required). If the sequences are 50 bases in length, then this is 500 Mb of sequencing information. If the sequences are 36 bases in length, then this is 360 Mb of sequencing data. If this single read is different from any 50 b stretch (if 50 b reads are used or from any 36 b stretch if 36 b reads are used) of sequence information in the human genome by 1 or more (depending on the set criteria) bases (substitutions, insertions or deletions in any position and in any combination), then the described method would identify it is unique to sample one (or non-host) and use it in conjunction with a search algorithm to find a known homologous sequence and a potential identity of the non-reference DNA.

Many types of data structures which provide efficient sequence lookup can be used such as, sorted arrays, suffix arrays, suffix trees, hash tables, any variation of the aforementioned structure and so on. Additionally combinations of these data structures, such as combination of sorted arrays, hash tables, and suffix trees within a single conglomerated data structure can be used. In one embodiment of a combined data structure, a hash table and a suffix tree can be used together. In this example, the prefix—first m bases of the sequence, is stored in a hash table while the suffix is stored in a suffix array. Such a data structure allows for compact representation of sequencing reads, thereby increasing lookup speeds. The data structures can use sequences or subsequences of a sequence as the searchable keys and can only need to organize the searchable keys to allow for searching. Even though there are two sequence formats, the per-base qualities can not be used as a searchable key and instead can be considered as data associated with the searchable keys.

In one example, the data structure can be a hash table that can be used in conjunction with genomic sequence data. The hash table can allow a way to determine the presence of a given sequence, and when a sequence is present can retrieve the associated number of copies the same sequence is detected in the sample, and can retrieve the associated per-base qualities of the sequence.

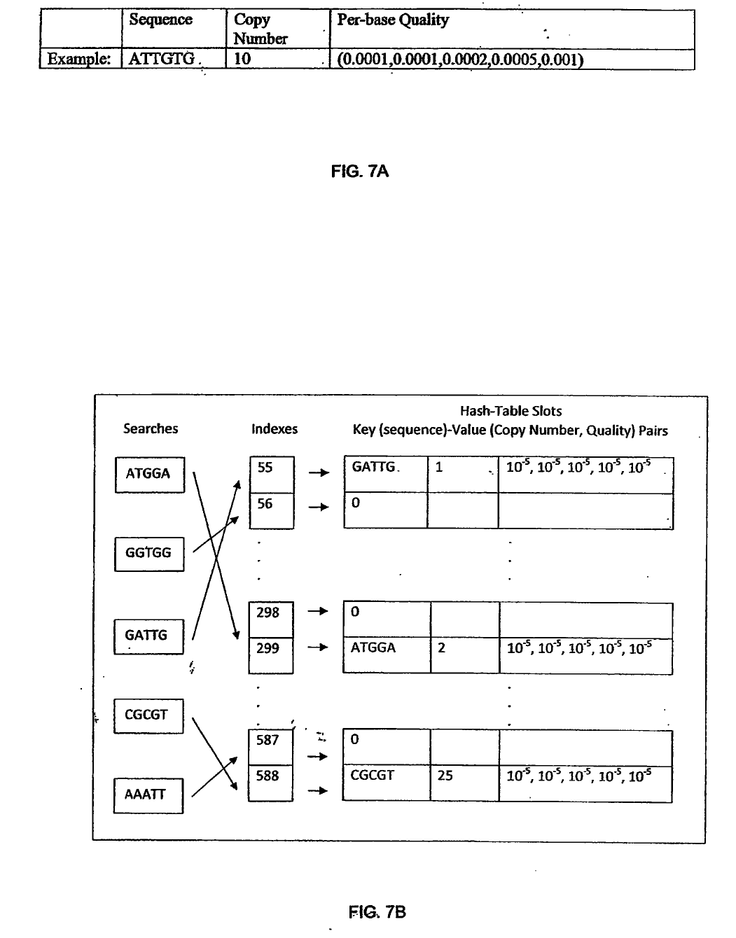

In one embodiment, the procedures “LOAD-SEQUENCES” and “LOAD-SEQUENCES-WITH-QUALITY” can load the nucleic acid sequences of the sample from a file into any of the data structures previously mentioned. The procedure LOAD-SEQUENCES can load the sequences of the sample without the per-base quality which can save memory space in the processor (which can also result in faster mapping and assembly than using the procedure LOAD-SEQUENCES-WITH-QUALITY), but can result in the loss of the ability to distinguish bad bases from good bases. The procedure LOAD-SEQUENCES-WITH-QUALITY can load sequences of the sample with their per-base qualities. Both procedures can save sequences with identical sequences only once with a copy number. FIG. 7A is an example of a sequence of the sample that can appear as a record. FIG. 7A includes some of the fields that can be used in a data structure, where the data structure can be used in conjunction with genomic sequence data.

In one embodiment, hashing can be used to implement a lookup table. FIG. 7B is an example of a hash table that employs nucleic acid sequences as keys. Additionally, any class of hashing functions can be used such as double hashing. In FIG. 7B, all keys can be added into the hash table that can be searched. Open-addressing can also be used as it can be the case that no keys were removed from the hash-table. The use of open-addressing can allow the organization of the internal lookup table in an array as opposed to an array of buckets (usually implemented as linked lists). The use of open-addressing can also conserve memory space that otherwise would be used to maintain pointers to buckets. Additionally, the use of the hash-table or any of the data structures mentioned previously can allow all sequences and their one, two, three, or more mismatches to be searched efficiently.

Another embodiment can implement a lookup table using sorted-arrays. The array can have the same or more elements as the number of keys and each array element can contain a record similar to the example shown in FIG. 7A. After the array is populated, the array can be sorted by the key, where various methods can be used to define a total order of the nucleic acid sequences such as lexicographically, numerically (by converting each sequence into a number first) and so on. Further, numerous sorting methods and any variation can be used such as bubble, sort, merge sort, heap sort, quick sort, and the like. The search process for a sorted-array can be a binary search of any variation thereof to locate the element that contains the matching sequence.

In yet another embodiment, a lookup table can be implemented using a binary-search-tree (“BST”). The BST can have nodes, where each node in the tree can contain a record such as the example of FIG. 7A. The nodes can also contain a pointer to a left sub-tree and a pointer to a right sub-tree. In one example, the left sub-tree of a node can contain only values less than the node's value and the right sub-tree of a node can contain only values greater than or equal to the node's value. Each node of the BST can contain the nucleic acid sequence as the value of the node and the other fields, such as copy number and per-base qualities, can be additional data that can be stored within the node. After building a BST, the sequence search can be performed by traversing the BST.

In still another embodiment, a lookup table can be implemented using a suffix-tree or any of its variations such as a suffix-array. A suffix-tree can use a collection of edges on the path from the root node to one of the leaf nodes to represent a nucleic acid sequence. Other fields, such as copy number and per-base qualities that are associated with a sequence can be stored in the corresponding leaf node. A search can be performed in a suffix-tree, after the suffix-tree is built, by traversing the tree from the root to one of its leaf nodes.

As discussed previously, mapping can be used in the identification of non-reference nucleic acid sequence in both the one-sample sequencing approach and the two-sample sequencing approach. Mapping can be used for determining how much of the reference genome or gene can be present in sequences of the sample. In the process of mapping, the assumption can be made that a sequence of the sample with high similarity to a subsequence in the reference genome or gene, is expected to be the result of sequencing that part of the reference genome or gene. Mapping involves finding a set of sequences of the sample that have high sequence similarity to the subsequences in the reference genome or gene and depending on the number of sequences of the sample found for a subsequence, the presence of the subsequence in the sample can be confirmed or rejected. Different levels of confidence for subsequences of the reference genome or gene can be determined using the number of sequences of the sample found and the per-base quality of the sequences of the sample. Thus, a higher confidence can be associated with a higher number of sequences of the sample or a higher per-base quality of the sequences of the sample.

The mapping step can map all sequences of the sample or subsequences of sequences of the sample to a reference sequence set ref_set using up to k (0 to k) mismatches. Procedure ALL-K-MISMATCH-VARIANTS (pseudo-code shown in Table 1 below) performs the operation of creating a set of all k mismatch variants of a given reference sequence (seq). The example in Table 1 achieves this by introducing all combinations of edits (insertions, deletions and substitutions of one nucleotide) in all permutations of k positions in the original sequence. In one example, a sequence X can be a k mismatch variant of a sequence Y (where the sequence X is the same size as the sequence Y), where the number of edits to convert sequence X into sequence Y, or vice versa, is k. Procedure ALL-K-MISMATCH-VARIANTS is used for both mapping and the de novo assembly in the one-sample sequencing approach and/or the two-sample sequencing approach.

TABLE 1
Procedure ALL-K-MISMATCH-VARIANTS(seq, K): Returns V

| | |
|---|---|
| 1 | If K = 0 |

| | |
|---|---|
| 2 | Then V ← seq |

| | |
|---|---|
| 3 | Return V |

| 4 | End If |
|---|---|
| 5 | pos_set ← all distinct permutations of values 1, 2, 3, ..., \|seq\| |
| | taken K values at a time |
| 6 | chg_set ← all combinations of values 1, 2, 3, 4, 5, 6, 7, 8, 9 picking |
| | K values at a time with replacement |
| 7 | base ← (A,T,G,C) |
| 8 | V ← 0 |
| 9 | For each p in pos_set |
| 10 | Begin For each c in chg_set |

| | |
|---|---|
| 11 | Begin variant ← null sequence |

| | |
|---|---|
| 12 | For x ← 1 To \|seq\| |
| 13 | Begin If x not-in p |

| | |
|---|---|
| 14 | Then append seq[x] to the end of variant |

| | |
|---|---|
| 15 | Else |

| | |
|---|---|
| 16 | Then a ← index of x in p |

| | |
|---|---|
| 17 | If c[a] is one of 1,2,3,4 // substitutions |

| 18 | Then append base[c[a]] to the end |
|---|---|
| | of variant |

| | |
|---|---|
| 19 | x ← x+1 |

| 20 | Else If c[a] is one of 5,6,7,8 // |
|---|---|
| | insertions |

| 21 | Then append base[c[a−4]] to |
|---|---|
| | the end of variant |

| | |
|---|---|
| 22 | Else If c[a] = 9 // deletion |

| | |
|---|---|
| 23 | Then x ← x+1 |

| | |
|---|---|
| 24 | End If |
| 25 | add variant to V |

| | |
|---|---|
| 26 | End |

| | |
|---|---|
| 27 | End |

| | |
|---|---|
| 28 | End |
| 29 | Return V |

As previously discussed with respect to FIGS. 3, 4 and 6, exact mapping can not include a mismatch, thus k=0. Additionally, mapping with mismatches can include one, two, three or more mismatches, thus k=1, 2, 3 or more. Furthermore, the set of reference sequences, ref_set, can contain the reference genome sequence (which can be sub-divided by chromosomes), or can contain any number of the reference sequences from the collection of known genomes or genes (as previously discussed, the collection can contain over 500,000 genomes or genes). For each subsequence r in ref_set, a set of sequences or subsequences of sequences S can exist that can be identical to some of the k mismatch variants of r. In this case, all sequences in S can be mapped to r.

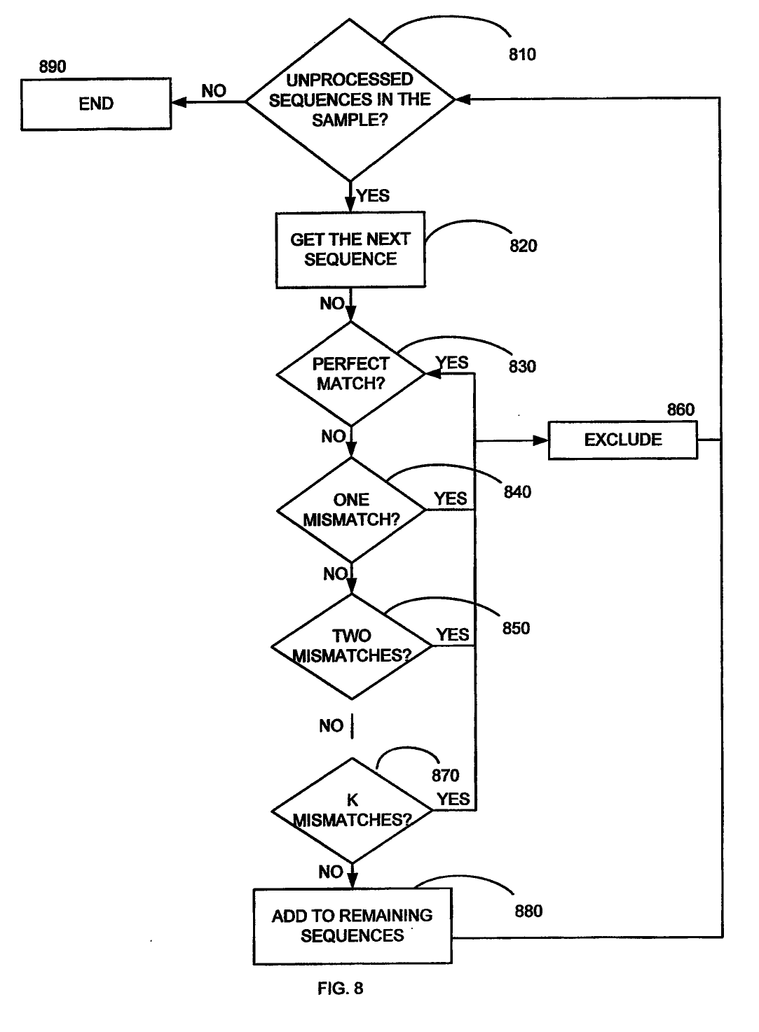

FIG. 8 is an example of a search strategy for finding the set of sequences of the sample or subset of sequences of the sample S that are identical to some of the k mismatch variants of r. Generally, the approach for checking the number of mismatches from 0 to k can be implemented by terminating the check when a sequence of the sample is mapped to some r with k mismatches. Stated differently, if a sequence of the sample is mapped to some r with k mismatches, then the check can be stopped and no further check for a k+1 mismatch can be made. In FIG. 8, an example of such a method 800 begins with the operation of block 810, checking for any unprocessed sequences in the sample. Unprocessed sequences in the sample can be sequences in the sample that have not been checked against either a set of sequences or subsequences of sequences of the sample genome sequence or any reference sequences of known genomes or genes. When there are no unprocessed sequences in the sample, the search is complete and the method 800 can proceed to the operation of block 890 where the search can terminate.

The method 800 can proceed to the operation of block 820 when there are unprocessed sequences of the sample and can obtain the next sequence of the sample. Once the sequence of the sample is obtained, in the operation of block 830, the sequence of the sample can be checked against either the reference genome sequence or any reference sequences or subsequences of known genomes or genes for a perfect match. If the sequence of the sample is a perfect match, the sequence of the sample can be excluded in the operation of block 860 and the sequence of the sample can not be checked against a reference genome sequence or any reference sequences or subsequences of known genomes or genes with one mismatch. In the event, the sequence of the sample is not a perfect match, the sequence of the sample can be checked again in the operation of block 840, against a reference genome sequence or any reference sequences or subsequences of known genomes or genes with one mismatch. If the sequence of the sample matches the reference genome sequence or any reference sequences or subsequences of known genomes or genes with one mismatch the sequence of the sample is excluded in the operation of block 860 and the sequence of the sample can not be checked for two mismatches. However, if the sequence of the sample does not match the reference genome sequence or any reference sequences or subsequences of known genomes or genes with one mismatch, the sequence can be checked against a reference genome sequence or any reference sequences or subsequences of known genomes or genes with two mismatches in the operation of block 850. As shown in FIG. 8, this process can continue for any k number of mismatches as depicted in the operation of block 870. Once the determination is made that the sequence of the sample does not match the reference genome sequence or any reference sequences or subsequences of known genomes or genes, the sequence of the sample is added to the remaining sequences in the operation of block 880 by sending the unmatched sequences back to the set of sequences in the operation of block 810. The sequences of the sample that can be sent from the operation of block 880 to the operation of block 810 can be processed sequences and thus, can not be checked again.

Table 2 provides pseudo code for performing the operation of excluding sequences of the sample from a given set of reference sequences. The procedure of Table 2 is similar to the method 800 of FIG. 8. The reference sequences can be a sequence or subsequence individually from a reference genome, a collection of all known genomes and genes, other nucleic acid sequences that can be present in the sample, or any combination thereof. The procedure of Table 2 can include inputs of a reference sequence (ref), a set of sequences of the sample (R), sequence size (N) and a maximum number of mismatches (K). All the sequences of the sample can have the same size N. The procedure of Table 2 can return a set of sequences of the sample that can not be mapped to a position in the reference sequence using 0 to K mismatches.

TABLE 2
Procedure MAP-SEQUENCES-TO-REFERENCE-SEQUENCE(ref,
R, N, K): Returns remaining

| | |
|---|---|
| 1 | For k ← 0 To K |
| 2 | Begin mapped ← Ø |

| | |
|---|---|
| 3 | For p ← 1 To \|ref\| |
| 4 | Begin V ← ALL-K-MISMATCH-VARIANTS (ref_{p,p+N-1+k}, k) |

| | |
|---|---|
| 5 | For each sequence r in V |
| 6 | Begin If r presents in R |

| | |
|---|---|
| 7 | Then add r to mapped |

| | |
|---|---|
| 8 | r′ ← reverse complement of r |
| 9 | If r′ presents in R |

| | |
|---|---|
| 10 | Then add r′ to mapped |

| | |
|---|---|
| 11 | End |

| | |
|---|---|
| 12 | End |
| 13 | R ← R - mapped |

| | |
|---|---|
| 14 | End |
| 15 | Return R |

The procedure of Table 2 can iterate k from 0 to K mismatches. After each iteration a sequence of the sample can be removed that is mapped to a position in the reference sequence from the set of sequences of the sample R. The set of sequences of the sample can be mapped to the reference sequence using any number of mismatches from zero mismatches (an exact match), one mismatch, two mismatches, and so on. A set of all k-mismatch variants (V) can be created by taking a subsequence of size N+k from each position of the reference sequence. In this context ref_{p,p+N-1+k} can refer to taking a subsequence of ref from position p to position p+N−1+k. N+k can be used instead of N to provide extra “suffix” bases for deletion as all k mismatch variants can have the same size N. Each k mismatch variant can be checked as well as its complement in R. If a sequence matches in R, then the sequence of the sample can be mapped and can be removed from R.

Table 3 provides pseudo code for performing the operation of removing sequences of the sample from R that are mapped to the set of reference sequences up to K mismatches and returned to the remaining sequences of the sample. The procedure of Table 3 can include at least the inputs of a set of reference nucleic acid sequences (ref_set), the set of sequences of the sample (R), the sequence size (N), maximum mismatches (K) and so on. The two-sample sequencing approach can employ the method of replacing the set of reference nucleic acid sequences ref_set with the set of sequences from the control sample. The two-sample sequencing approach can be similar to the one-sample sequencing approach with respect to the rest of the mapping methodology. However, the analysis of the two-sample sequencing approach can be performed by using sub-sequences of sequences where the subsequences can be a size shorter than N.

TABLE 3
Procedure EXCLUDE-SEQUENCES-FROM-REFERENCE-
SET(ref_set, R, N, K): Returns remaining

| | |
|---|---|
| 1 | For Each ref in ref_set |

| 2 | Do R ← |
|---|---|
| | MAP-SEQUENCES-TO-REFERENCE-SEQUENCE(ref, R, |
| | N, K) |

| | |
|---|---|
| 3 | Return R |

Assembly, as previously discussed with respect to FIG. 2, can include the process of finding overlapping sequences of the sample that can form a contiguous subsequence in the actual genome in the sample. The process of assembly begins by picking a sequence of the sample to be the “seed.” A sequence of the sample with high copy numbers is typically a good seed because it is less likely to be an artifact of sequencing error. A user can determine a threshold value (minimum copy number) for which a sequence of the sample must have to qualify to be a seed. This value is given in Pmin_n_copies in Table 4. The histogram of copy numbers from all sequences of the sample can help determine the minimum copy number. This sequence of the sample can be referred to herein as a template for explanatory purposes only. We use the idea of “overlap” to extend a template. Two sequences can extend each other if a subsequences from the 5′-end (left end) of a sequence is the same as a subsequence from the 3′-end (right end) of another sequence, or if a subsequences from the 3′-end of a sequence is the same as a subsequence from the 5′-end of another. Note that two sequences do not extend each other if a subsequences from the 5′-end (left end) of a sequence is the same as a subsequence from the 5′-end, or if a subsequences from the 3′-end (left end) of a sequence is the same as a subsequence from the 3′-end. For example, AGGTTACC and CGCTAGG extends each other, while AGGTTACC and AGGTTGGG do not extend each other. We extend the template using an iterative process. In each iteration, we search for sequences of the sample that overlap with the template. We start by looking for all sequences of the sample that overlap the template by subsequence of N−1 bases, and with 0, 1, 2, . . . up to K mismatches. Each sequence of the sample which overlaps the template “casts a vote” on what the next base may be (each overlapping sequence cast 1 vote). For example, suppose ATTGG is the template, TTGGA would cast a vote on ‘A’ being the next base, and TTGGC would cast vote on ‘C’ being the next base. Decision rules can be applied to determine the most likely base. When more than one bases are equal likely to be the next base then the extension process stops, and output the current template.

User can specify the minimum size of the overlapping subsequence (a value less than or equals to N−1). This value is given as Pmax_shearing in Table 5 where the difference between N and Pmax_shearing is the minimum size of the overlapping subsequence. Thus, the process will first count the votes from sequences of the sample overlapping with N−1 bases and its 1, 2, 3 . . . K mismatch variants, then count the votes from sequences of the sample overlapping with N−2 bases and its 1, 2, 3, . . . K mismatch variants, and so on until N-Pmax_shearing. Next a decision rule can be applied to determine the most likely next base.

In the methodology described in Table 5, we use a majority rule to determine the next base. In addition we require that the winning base must have at least a given amount of votes (Pmin_%: minimum percentage of votes the base which have the majority of votes must have in order to be the next base). If none of the bases meets this requirement then the extension process stops. Table 6 and Table 7 show our methodologies for finding the next base to the 5′ end of the template, and to the 3′ end of the template. The procedure Complementary returns the complementary base of a given base (complementary of A is T and vice versa; complementary of G is C and vis versa). The procedure Reverse-Complementary returns the reverse complementary sequence of a given sequence (i.e. the reverse complementary of ATGC is GCAT).

TABLE 4
Procedure PICK-SEED SEQUENCES(R, Pmin_n_copies):
Returns seed sequences

seed sequences ← null-set
For each r in R
Begin If r.copies >= Pmin_n_copies

Then seed sequences ← seed sequences union with r

End
Return seed sequences

TABLE 5
Procedure ASSEMBLE(R, seed sequences, N, K, Pmin_contig_size,
Pmax_shearing, Pmin_%): Returns contigs

contigs ← null-set
While seed sequences != null-set
Begin contig ← remove a sequence from seed sequences

// Extend on the 5′ end
b ← Extend-5′(R, N, K, contig, Pmax_shearing, Pmin_%)
While b != null
Begin contig ← b + contig

b ← Extend-5′(R, N, K, contig, Pmax_shearing, Pmin_%)
Remove b_{1,N} from R

End
// Extend on the 3′ end
b ← Extend-3′(R, N, K, contig, Pmax_shearing, Pmin_%)
While b != null
Begin contig ← contig + b

b ← Extend-3′(R, N, K, contig, Pmax_shearing, Pmin_%)
Remove b_{|b|-N,N}from R

End
If |contig| >= Pmin_contig_size

Then contigs ← contigs union with contig

End If
remove subsequences of contig from seed sequences

End

TABLE 6
Procedure EXTEND-5′(R, N, K, contig, Pmax_shearing, Pmin_%)

bases ← (‘A’, ‘T’, ‘G’, ‘C’)
votes ← (0, 0, 0, 0)
For b ← 1 To 4
Begin V ← null-set

For d ← 1 To Pmax_shearing
Begin If d = 1

Then V1 ← {empty sequence}

Else

Then V1 ← {all possible sequences with d−1 bases}

End If
For k ← 0 To K
Begin For each v1 in V1

Begin V ← V union with ALL-K-MISMATCH-VARIANTS(v1+base[b]+contig_{1,N-d},

k)

For each v in V
Begin If v in R

Then votes[b] ← votes[b] + R[v].copies

End

End

End

End

End
If max(votes) − 2^{nd}_max(votes) / 2^{nd}_max(votes) >= Pmin_%

Then Return bases[index_of_max(votes)]

Else

Then Return null

End If

TABLE 7
Procedure EXTEND-3′(R, N, K, contig, Pmax_shearing, Pmin_%)

bases ← (‘A’, ‘T’, ‘G’, ‘C’)
votes ← (0, 0, 0, 0)
For b ← 1 To 4
Begin V ← null-set

For d ← 1 To Pmax_shearing
Begin If d = 1

Then V1 ← {empty sequence}

Else

Then V1 ← {all possible sequences with d−1 bases}

End If
For k ← 0 To K
Begin For each v1 in V1

Begin V ← V union with ALL-K-MISMATCH-VARIANTS(contig_{1,N-d} +

base[b] + v1, k)

For each v in V
Begin If REVERSE-COMPLEMENTARY(v) is in R

Then votes[b] ← votes[b] + R[reverse-complementary(v)].copies

End

End

End

End

End
If max(votes) − 2^{nd}_max(votes) / 2^{nd}_max(votes) >= Pmin_%

Then Return COMPLEMENTARY(bases[index_of_max(votes)])

Else

Then Return null

End If

### Computer Systems and Computer Readable Media

Embodiments within the scope of the invention include computer systems configured to perform the methods disclosed herein.

Computer systems are generally well-known in the art. Those skilled in the art will appreciate that aspects of the invention can be practiced in computing environments or network computing environments with many types of computer system configurations, including personal computers, hand-held devices, multi-processor systems, microprocessor based or programmable consumer electronics, network PCs, minicomputers, mainframe computers, and the like. Various embodiments discussed herein, including embodiments involving a satellite or cable signal delivered to a set-top box, television system processor, or the like, as well as digital data signals delivered to some form of multimedia processing configuration, such as employed for IPTV, or other similar configurations can be considered as within a network computing environment. Further, wirelessly connected cell phones, a type of hand-held device, are considered as within a network computing environment. For example, cell phones include a processor, memory, display, and some form of wireless connection, whether digital or analog, and some form of input medium, such as keyboards, touch screens, etc.

Hand-held computing platforms can also include video on demand type of selection ability. Examples of wireless connection technologies applicable in various mobile embodiments include, but are not limited to, radio frequency, AM, FM, cellular, television, satellite, microwave, WiFi, blue-tooth, infrared, and the like. Hand-held computing platforms do not necessarily require a wireless connection. For example, a hand-held device can access multimedia from some form of memory, which can include both integrated memory (e.g., RAM, Flash, etc) as well as removable memory (e.g., optical storage media, memory sticks, flash memory cards, etc.) for playback on the device. Aspects of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

In certain embodiments, computer systems include a processor configured to perform the methods disclosed herein. The computer system can be configured to identify sequences as described herein. The processor can be further configured to identify the sequences, compare sequences, process sequences, exclude sequences, and so on. In other variations, the computer systems described herein can comprise a processor configured to implement the processes using various data structures as described herein.

Embodiments within the scope of the present invention also include computer readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, DVD, CD ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the source of the information can be properly viewed as a computer-readable medium, such as a server, a storage medium, a processor, and the like.

Combinations of the above should also be included within the scope of computer-readable media. Computer-executable instructions comprise, for example, instructions and data which cause a general purpose computer, special purpose computer, or special purpose processing device to perform a certain function or group of functions.

### Uses of Methods, Computer Systems and Computer Readable Media

The methods described herein can be used to identify sequences from a particular source. The sequences are identified rapidly by eliminating sequences that are either already known as described above. In various embodiments, sequences can correspond to a particular environment, organism, disease state, or condition can be identified. The presence of nucleic acid sequences can be identified in an individual organism, or group of organisms. The methods described herein can be used to identify any unknown sequences that are from a particular source. The presence of unknown genomic material in any sample, including environmental samples and suspicious samples can be identified.

In one embodiment, the sequence can correspond to non-host nucleic acid sequences (i.e., sequences not normally associated with a host organism). The term “host” can refer to an animal or plant that has been or is infected by another organism, examples of animals can include mammals, non mammals, and invertebrates. Examples of mammals include humans, non-human primates, farm animals, sport animals, mice, and rats. Examples of plants include, but are not limited to, agricultural crops. In general, host organisms have been infected by a microorganism, such as a virus, bacterium or fungus, parasite, protozoan. By eliminating sequences corresponding to the host organism, and then eliminating sequences corresponding to known microorganism sequences, new nucleic acid sequences that correspond to a previously unknown microorganism can be identified.

Alternatively, the methods described herein can be used to identify nucleic acid sequences associated with a disease or condition in an organism, such as an animal or plant. The condition may not even be infectious/contagious at the current time. Sequences from samples of healthy tissue and diseased tissue can both be obtained. Sequences corresponding to healthy tissue can then be identified and removed from the set of disease sequences as described herein. Alternatively, sequences corresponding to other known sequences can be eliminated. The remaining sequences correspond to diseased tissue. Exemplary embodiments of the disease or condition include cancer or a type of cancer, or an organ suitable for transplantation. Disease progression can also be monitored.

In various other embodiments, nucleic acid sequences associated with foreign genetic material in an ingestible product can be identified. For example, nucleic acid sequences that are indicators of foreign material in foodstuffs (e.g. food manufacturing and/or beverage processing), medicines, or vaccines can be determined. Foreign nucleic acid sequences in this context are identified as “non-reference” sequences, where the foodstuff, medicine, or vaccine is the “reference.” The suitability of material to leave quarantine or to be distributed can also be determined based on the amount of foreign nucleic acid material present in the sample. The presence of foreign genomic material in tissue culture used for the generation of therapeutics can be determined.

Other applications of the methodologies described herein can include, but are not limited to identifying genomic material associated with a particular type of cancer, such as the cause of the particular type of cancer, identifying genomic material associated with a chronic disease/condition where the condition may not be infectious and/or contagious at the current time, identifying genomic material associated with an “apparently” infectious disease, where there can be no cultivatable cause and so on. Other applications can include the determination of suitability of organs for transplant, the suitability of material to leave quarantine, suitability of material for distribution, the presence of novel nucleic acid sequence material in returning astronauts, the sterility of plant tissues. The methodologies described herein can be used to determine the presence of foreign genomic material in tissue culture used for generation of therapeutics, the presence of foreign genomic material in vaccine materials, the presence of foreign genomic material in food processing and the presence of foreign material in beverage manufacturing. Furthermore, the nature of an emerging disease can be determined using the methodologies described herein. Additionally, the methodologies described herein can be used to identify the presence of unknowns in any sample, the presence of unknowns in an environmental sample and the presence of unknowns in a suspicious sample.

It will be understood to those of skill in the art that the methods disclosed herein can be adapted to other types of biological sequences, such as protein sequences and carbohydrates. In the case of protein sequences, the amino acids include 20 letters (corresponding to naturally occurring amino acids) as opposed to 4 letter alphabet of nucleic acid sequences. The algorithms and data-structures disclosed herein can thus be adapted to the 20 letter alphabet for reference and non-reference sequences.

Although the present disclosure has been described with respect to particular apparatuses, configurations, components, systems and methods of operation, it will be appreciated by those of ordinary skill in the art upon sequencing this disclosure that certain changes or modifications to the embodiments and/or their operations, as described herein, can be made without departing from the spirit or scope of the disclosure. Accordingly, the proper scope of the disclosure is defined by the appended claims. The various embodiments, operations, components and configurations disclosed herein are generally exemplary rather than limiting in scope.

1. A method for identifying one or more non-reference nucleic acid sequences in a sample comprising:
receiving, through a communication interface and from a sequencing system, a set of nucleic acid sequences from a sample, wherein the communication interface is a part of system, the system further comprising a processor and a memory, the processor operable to execute instruction code stored in the memory and the memory operable to store one or more nucleic acid sequence data structures;
storing the set of nucleic acid sequences in a first data structure in the memory;
receiving, through the communication interface, a set of reference nucleic acid sequences wherein the reference sequences correspond to known sequences for a sample type;
storing the reference sequences in a second data structure in the memory;
comparing, by the processor, the first data structure to the second data structure; and
excluding, by the processor, one or more sequences of the sample that are associated with the sequences in the second data structure to identify one or more non-reference nucleic acid sequences.

2. The method of claim 1, wherein the second data structure is a hash table.

3. The method of claim 1, wherein the second data structure is a sorted array.

4. The method of claim 1, wherein the second data structure is a suffix array.

5. The method of claim 1, wherein the second data structure is a suffix tree.

6. The method of claim 1 further comprising assembling the non-excluded sample sequences in the second data structure into a new sequence.

7. The method of claim 1, further comprising obtaining the sample sequences.

8. The method of claim 1 wherein said step of comparing the first data structure to the second data structure comprises mapping the sample sequence to the sequences in the second data structure with no mismatches between said sample sequences and said sequences in said second data structure or at least one mismatch between said sample sequences and said sequences in said second data structure.

9. The method of claim 1 further comprising comparing said one or more sample sequences to a set of all k mismatch variants, wherein k is the number of mismatches in the sample sequence.

10. A method of mapping a sample sequence to any known sequence in a data set comprising:
receiving, through a communication interface and from a sequencing system, a sample sequence of nucleic acid from a sample, wherein the communication interface is a part of system, the system further comprising a processor and a memory, the processor operable to execute instruction code stored in the memory and the memory operable to store one or more nucleic acid sequence data structures;
storing the sample sequences in a first data structure in the memory;
receiving, through the communication interface, a set of reference nucleic acid sequences wherein the reference sequences correspond to any known sequence;
storing the reference sequences in a second data structure in the memory;
comparing, by the processor, the sample sequence in the first data structure to any known sequence the second data structure, with no mismatches;
terminating, by the processor, the comparing step when the sample sequence maps exactly to the at least one sequence in the second data structure with no mismatches.

11. The method of claim 10 further comprising:
comparing, by the processor, the sample sequence with at least one sequence in the second data structure with one mismatch;
excluding, by the processor, the sample sequence from the set of sample sequences when the sample sequence matches at least one sequence in the second data structure with one mismatch; and
terminating, by the processor, the mapping when the unprocessed sample sequence maps to the at least one sequence in the second data structure with one mismatch.

12. The method of claim 10 further comprising:
returning, by the processor, the sample sequence to the set of sample sequences when the sample sequence does not map to any of the sequences in the second data structure with one mismatch.

13. The method of claim 10 further comprising locating, by the processor, the sequences in the second data structure, wherein the data structure is a hash table.

14. The method of claim 10 further comprising populating the second data structure with the sequences, wherein the second data structure is a sorted array.

15. The method of claim 10 further comprising populating the second data structure with the sequences, wherein the second data structure is a suffix array.

16. The method of claim 10 further comprising populating the second data structure with the sequences, wherein the second data structure is a suffix tree.

17. The method of claim 10 further comprising using the sample sequences that do not map to the sequences in the second data structure to assemble a new sequence.

18. A method for assembling a set of sample sequences into a new sequence comprising:
forming, by a processor, a template sequence from at least two overlapping sequences that forms a contiguous subsequence in the sample as a template, wherein the processor is a part of system, the system further comprising a memory and a communication interface, the processor operable to execute instruction code stored in the memory and the memory operable to store one or more nucleic acid sequence data structures;
iteratively extending, by a processor, the template on both ends of the template, said extending comprising:
defining, by the processor, a subsequence from at least one end of the template as a seed sequence, wherein the size of the subsequence is less than the size of the sequence;
appending, by the processor, all possible sequences to the end of the seed sequence, wherein the size of all the possible sequences is the difference between the sequence size and the seed; and
checking all possible sequences for k mismatch variants; and
outputting a new sequence as part of a data stream through the communication interface.
